(19) United States
(12) Patent Application Publication
(10) Pub. No.: US 2015/0263651 A1
(43) Pub. Date: Sep. 17, 2015

(54) MOVABLE BARRIER OPERATOR WITH BACKUP CONTROL MODULE

(71) Applicant: Viking Access Systems, LLC, IRVINE, CA (US)

(72) Inventor: Ali Tehranchi, Irvine, CA (US)

(21) Appl. No.: 14/659,298

(22) Filed: Mar. 16, 2015

Related U.S. Application Data
(60) Provisional application No. 61/953,131, filed on Mar. 14, 2014.

(51) Int. Cl. H02P 4/00; H02P 29/02

(52) U.S. Cl. CPC H02P 4/00; H02P 29/02

(57) ABSTRACT

The present invention is generally a movable barrier operator with a backup control module that enables a secondary means of delivering power and facilitating control for actuating the motor in order to move a barrier without accessing the main controller. In an exemplary embodiment, a motor may be adapted to mechanically control a movable barrier from alternative power sources. One power source may provide power to a controller serving as the main controller of the operator. This power source may power an adjacent charger that charges a battery. A set of switches or relays, may connect the motor to both the main controller and the battery. In the event of a malfunction, the motor may be disconnected from the main controller and actuated directly by the battery power. To achieve this, various embodiments may be implemented without limiting the scope for the present invention.

### PRIORITY NOTICE

The present application claims priority under 35 U.S.C. §119(e) to U.S. Provisional Patent Application Ser. No. 61/953,131 filed on Mar. 14, 2014, the disclosure of which is incorporated herein by reference in its entirety.

### TECHNICAL FIELD OF THE INVENTION

The present invention relates in general to a movable barrier operator with a backup control module, and more specifically, to a movable barrier operator with a backup control module that enables a secondary means of delivering power and facilitating control for actuating the motor in order to move a barrier without accessing the main controller.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Typically, operators utilize controllers for activating motors and gears that in turn move barriers between an open and closed position. When a controller becomes disabled, either because of maintenance or due to a system malfunction, the movable barrier is also disabled. Typical malfunctions may include a burnt relay, a short circuit in the controller, or damaged transistors, which result in damage to the main controller of the operator. In the past, various mechanisms have been used to disengage a barrier from the motor in order to allow manual movement of the barrier during a controller malfunction.

One solution has been to provide disengagement means to decouple a mechanism such as a chain running between a gearbox and the barrier in order allow free movement of the barrier along its track. Another solution has been to provide a mechanism for decoupling an arm that connects the motor or gearbox to the barrier, in order to allow free movement of the barrier, which typically swings from another arm independent of the gearbox and motor. Yet another solution has been to provide a gearbox with backwards drive capabilities in order to allow a barrier to be pushed in a desired direction even if the motor cannot be actuated.

These solutions are limited however, since they require manual adjustment of the barrier. Additionally, in the event of technical malfunctions, it is desirable to actuate the barrier without having to resort to manual operation.

Therefore, there is a need in the art for a movable barrier operator that implements a backup control module for actuating a movable barrier in the event of a controller being disabled, whether the controller is disabled for maintenance purposes or as a result of a technical malfunction. It is to these ends that the present invention has been developed.

### BRIEF SUMMARY OF THE INVENTION

To minimize the limitations in the prior art, and to minimize other limitations that will be apparent upon reading and understanding the present specification, the present invention describes a movable barrier operator with a module that enables a secondary means of delivering power and enabling control to actuate the motor in order to move a barrier without accessing the main controller.

A movable barrier operator in accordance with one embodiment of the present invention, comprises: a motor mechanically coupled to a movable barrier; a power supply module for supplying power to the motor, the power supply module including: a first power supply interface, and a second power supply interface; a controller connected to the power supply module via the first power supply interface, the controller configured to actuate movement of the movable barrier by generating a command signal to drive the motor when the controller is connected to the motor; and a switch module connected to the motor and configured to: selectively connect the motor to the controller in order to actuate the movable barrier by supplying power to the motor via the first power supply interface; or selectively connect the motor directly to the power supply module in order to actuate the movable barrier by supplying power to the motor via the second power supply interface.

A movable barrier system in accordance with one embodiment of the present invention, comprises: a movable barrier; and a movable barrier operator coupled to the movable barrier, the movable barrier operator including: a motor mechanically coupled to the movable barrier; a power supply module for supplying power to the motor, the power supply module including: a first power supply interface, and a second power supply interface; a controller connected to the power supply module via the first power supply interface, the controller configured to actuate movement of the movable barrier by generating a command signal to drive the motor when the controller is connected to the motor; and a first switch coupled to the motor, the first switch configured to selectively connect the motor to the controller in order to actuate the movable barrier by supplying power to the motor via the first power supply interface; and a second switch coupled to the first switch and power supply module, wherein the first switch is further configured to selectively connect the motor to the second switch, and wherein the second switch is configured to actuate the movable barrier by supplying power to the motor via the second power supply interface.

A movable barrier operator in accordance with another embodiment of the present invention, comprises: a motor mechanically coupled to a movable barrier; a first power supply for selectively supplying power to the motor; a second power supply including a charger configured to draw power from the first power supply and a battery coupled to the charger and configured to selectively supply power to the motor; a controller that draws power from the first power supply, the controller configured to actuate movement of the movable barrier by generating a command signal to drive the motor when the controller is connected to the motor; a switch array connected to the motor and configured to: selectively connect the motor to the controller in order to actuate the movable barrier by supplying power to the motor via the first power supply; or selectively connect the motor to the second power supply in order to actuate the movable barrier by supplying power to the motor via the battery.

It is an objective of the present invention to provide an alternative or backup control module for actuating a barrier without accessing the operator's controller.

It is another objective of the present invention to provide a means of controlling a barrier in the event of a system malfunction that disables the operator's controller.

It is yet another objective of the present invention, to provide a means of controlling a barrier during routine system maintenance that requires disabling the operator's controller.

It is yet another objective of the present invention, to provide a backup control module that utilizes switches or relays in order to actuate the motor from an alternative power source or a power supply that circumvents the operator's controller.

These and other advantages and features of the present invention are described herein with specificity so as to make the present invention understandable to one of ordinary skill in the art.

### BRIEF DESCRIPTION OF DRAWINGS

Elements in the figures have not necessarily been drawn to scale in order to enhance their clarity and improve understanding of these various elements and embodiments of the present invention. Furthermore, elements that are known to be common and well understood to those in the industry are not depicted in order to provide a clear view of the various embodiments of the invention.

FIG. 1 depicts a block diagram of a movable barrier typically found in the prior art.

FIG. 2(a) depicts a block diagram illustrating the various components of a movable barrier operator in accordance with one embodiment of the present invention.

FIG. 2(b) depicts a block diagram illustrating the various components of a movable barrier operator in accordance with another embodiment of the present invention.

FIG. 3(a) depicts a block diagram illustrating the various components of a movable barrier operator in accordance with one embodiment of the present invention.

FIG. 3(b) depicts a block diagram illustrating the various components of a movable barrier operator in accordance with another embodiment of the present invention.

FIG. 4(a) depicts a block diagram illustrating the various components of a movable barrier operator in accordance with one embodiment of the present invention.

FIG. 4(b) depicts a block diagram illustrating the various components of a movable barrier operator in accordance with another embodiment of the present invention.

### DESCRIPTION OF THE INVENTION

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

In the following detailed description, a movable barrier operator system may be any system that controls a barrier to an entry, an exit, or a view. The movable barrier could be a door for a small entity (i.e. a person), or a gate for a large entity (i.e. a vehicle), which may swing out, slide open, roll upwards, or achieve any other type of action suitable to control access through the movable barrier. The operator, which actuates or controls the movable barrier, may move the movable barrier from an open position to a closed position and vice-versa. The operator may be automatic and may be controlled locally or remotely. Additionally, an operator may comprise of a complex set of motors for moving one or more barriers, or a simple motor for opening, closing, or otherwise controlling movement of a single barrier. Furthermore, a controller, in the following description, may include one or more processors or microprocessors configured to access and execute a set of instructions for actuating the motor of the operator, in order to move or control the barrier. An operator in accordance with the present invention may implement a switching mechanism in order to alter or switch between paths of a power transmission from a power supply to the motor, which circumvents the main controller so that the motor may be driven while the main controller is off line. As such, in the present disclosure a switch, switch mechanism, or switch module may include any one or more mechanical switches, electromagnetic switches, switch arrays, relays, solid state devices such as solid state relays, solid state transistor devices such as bipolar junction transistors, field effect transistors, insulated-gate bipolar transistors, or any other suitable device that may provide efficient and fast means of switching an electric power transmission.

Generally, the present invention involves a movable barrier operator with a backup control module, and more specifically, to a movable barrier operator with a backup module that enables a secondary means of delivering power and enabling control for actuating the motor in order to move a barrier without accessing the main controller. In one exemplary embodiment, a motor may be adapted to mechanically control a movable barrier from a power supply module including multiple power supply interfaces. A first power supply interface may supply power to the main controller, which in turn supplies power to the motor. A second power supply interface may supply power to the motor by circumventing the main controller. A switch module or set of switches may selectively connect the motor to: (a) the main controller (drawing power from the power supply via the first interface) or (b) directly to the power supply module (supplying power to the motor via the second interface). In the event that the main controller needs to be taken off line, the switch module may enable disconnecting the motor from the main controller and connecting the motor to the power supply module so as to circumvent the main controller. In another exemplary embodiment, a motor may be adapted to mechanically control a movable barrier from alternative power supplies. One power supply may provide power to a controller serving as the main controller of the operator. This power supply may further provide power to a second power supply such as via an adjacent charger that charges a battery (i.e. the second power supply). A switch module or set of switches may selectively connect the motor to the main controller (which draws power from the first power supply) or the battery (i.e. the second power supply). In the event of a malfunction, the switch module may be engaged in order to disconnect the motor from the main controller and connecting the motor to the battery so as to circumvent the main controller. To achieve this, various embodiments may be implemented without limiting the scope for the present invention.

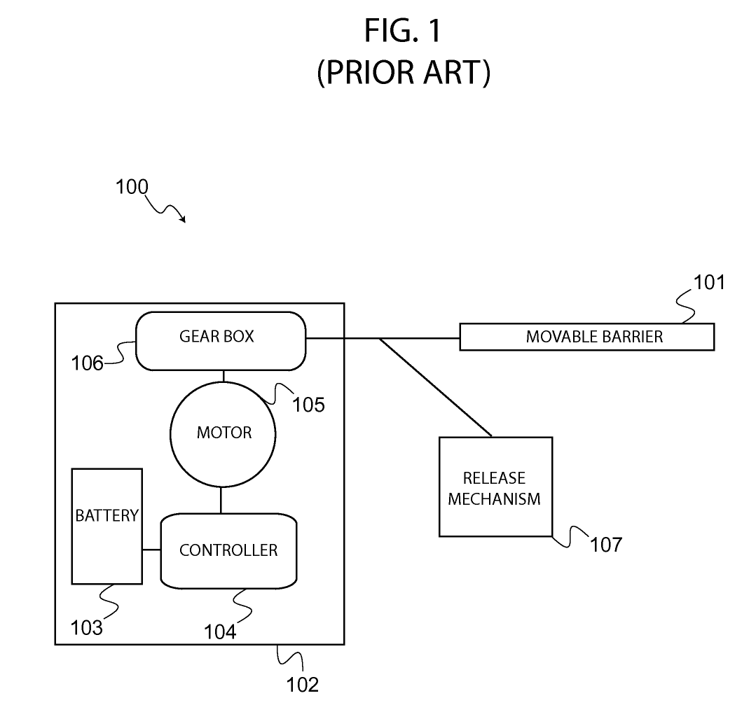

FIG. 1 depicts a block diagram of a movable barrier typically found in the prior art. More specifically, FIG. 1 shows a block diagram of prior art movable barrier operator system 100. System 100 controls access through movable barrier 101, and comprises movable barrier operator 102, including a battery 103 for supplying power to operator 102, controller 104 which governs control over movement of barrier 101, motor 105, which drives gearbox 106 to move movable barrier 101. As mentioned above, some operators in the field may include mechanisms to disengage a barrier from the motor in order to move the barrier during a system malfunction. As such, prior art system 100 may include release mechanism 107 for mechanically disengaging motor 105 in order to move barrier 101 in the event controller 104 or any other external components such as an external sensor malfunctions.

This is cumbersome and undesirable for various reasons, including the requirement for manual adjustment of barrier 101. For example, problems with controller 104 may prevent controller 104 from sending the appropriate command to motor 105. Alternatively, a problem with an external sensor malfunction may be signaling controller 104 to prevent motor 105 from driving barrier 101 to closed position. Because having to rely on release mechanism 107 is cumbersome and typically requires calling a technician, it is desirable to configure an operator to bypass controller 104, and/or other external devices that may communicate with (i.e. and under certain circumstances, may interfere with) operator 102.

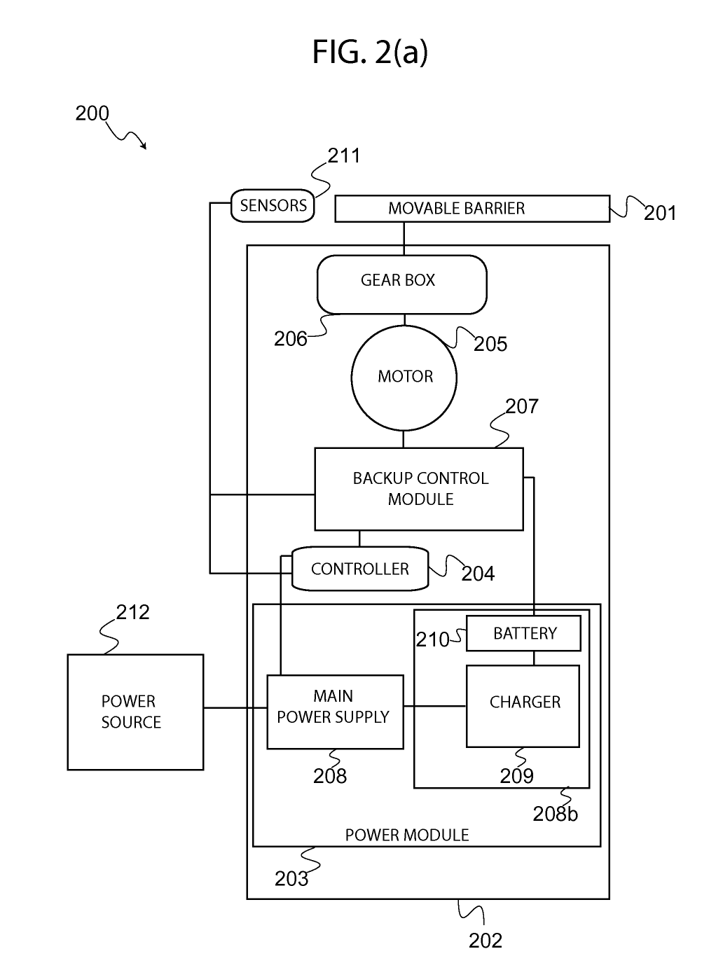

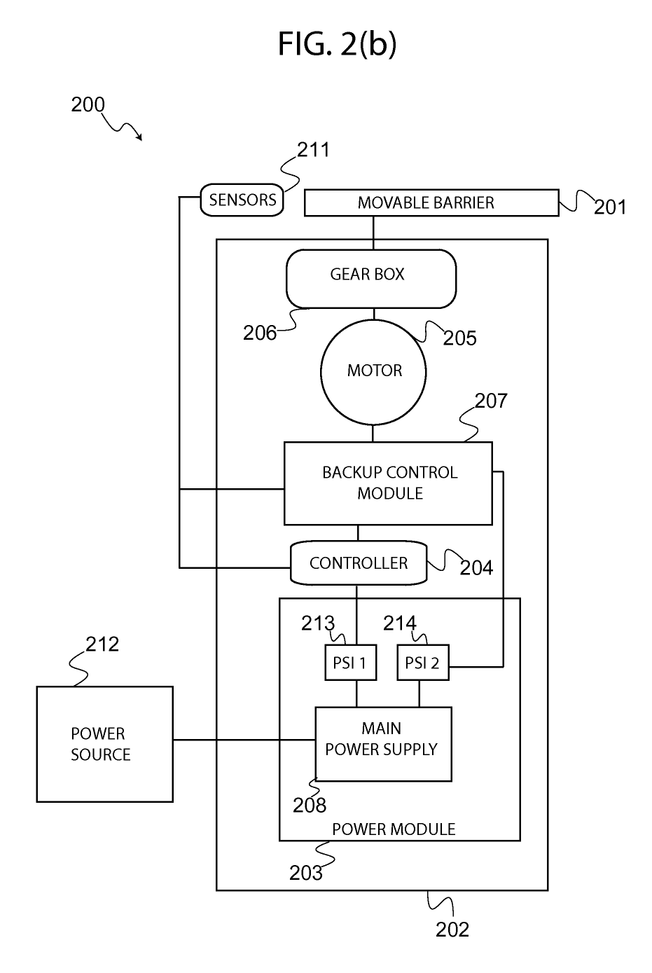

Turning now to the first figure depicting the present invention, FIG. 2(a) depicts a block diagram illustrating the various components of a movable barrier operator in accordance with one embodiment of the present invention. More specifically, FIG. 2(a) shows a block diagram of movable barrier operator system 200, which includes a movable barrier (barrier 201), operated by a movable barrier operator (operator 202).

Barrier 201 may be any type of barrier suitable for controlling access to a secured space, an entry, an exit or a view; hence barrier 201 may be a sliding gate, a swing gate, a roll-up gate, or any other known barrier type without deviating from the scope of the present invention. For example, and without limiting the scope of the present invention, barrier 201 may be a sliding gate that includes wheels that run on a track, which allow barrier 201 to slide or run on the track between an open and closed position. In exemplary embodiments, control of barrier 201 may be aided by sensors 211, which may include obstruction sensors such as photo-sensors for detecting whether an obstruction should signal controller 204 to prevent movement of barrier 201.

Operator 202 may be any type of operator suitable for controlling barrier 201; that is, operator 202 may be a swing gate operator, a slide gate operator, a roll-up gate operator, or any other type of operator without deviating from the scope of the present invention. For example, and without limiting the scope of the present invention, operator 202 may be a sliding gate operator. Operator 202 includes power module 203, controller 204, motor 205, gearbox 206, which is mechanically adapted to move barrier 201, and back-up control module 207 for enabling a secondary power supply and means to control motor 205, which circumvents the main power supply and controller 204 in the event a system 200 malfunction or maintenance routine requires movement of barrier 201 without its usual resources (i.e. controller 204). As such, system 200 obviates prior art systems such as release mechanism 107 of system 100.

Motor 205 may be any type of motor suitable for moving barrier 201 between an open and closed position. As such, motor 205 may be a Lorentz force motor, a hub motor, a DC motor, an AC motor, or any other type of motor known in the art and suitable for controlling barrier 201.

Gearbox 206 may be any type of suitable gearbox for facilitating movement of barrier 201, and is preferably a compact gearbox that allows for an efficient use of space within the operator 202's housing. In some embodiments, gearbox 206 may be omitted altogether from operator 202 and operator 202 may implement a motor such as a Lorentz force motor or hub motor coupled directly to barrier 201.

Power module 203 is typically configured for drawing power from power source 212 and supplying power to the various components of operator 202; Power Module 203 may include a suitable power supply for powering internal components, as well as a secondary power supply that may be configured to supply power to motor 205 whenever the secondary power supply is engaged. Power module 204 may comprise any number of configurations including: access to an external power source such as power source 212; a primary or first power supply 208 for supplying power to controller 204 (and thereby to motor 205) under typical operational conditions; a secondary or second power supply 208b including a rechargeable means of charging the second power supply from the first power supply, for example, charger 209 for charging battery 210; and any other necessary components suitable for safely supplying power to operator 202 components. As will be explained further below, power supply module 203 may be configured to selectively supply power to motor 205 via controller 204 or by circumventing controller 204—for example, directly from second power supply 208b to motor 205 by a means of a switch module included in backup control module 207 that enables the selective connection between motor 205 and controller 204 or motor 205 and second power supply 208b.

Controller 204 may comprise of one or more processors configured to access and execute a set of instructions for actuating motor 205 in order to move or control barrier 201. As the primary means of actuating motor 205 in order to move barrier 201, controller 204 may be configured for tasks such as: receiving signals pertaining to the detection of obstructions via sensors 211; generating barrier commands that stop or drive movement of barrier 201; provide a means to input programmable routines for actuating motor 205; executing diagnostic routines on operator 205; and perform functions typically required for controlling a movable barrier. From time to time, controller 204 may require routine maintenance or may be otherwise unavailable, for example due to some sensor malfunction that sends an erroneous signal to controller 204, preventing controller 204 from actuating motor 205 and controlling movement of barrier 201. In such occasions, it may be desirable to circumvent controller 204 by disconnecting controller 204 from motor 205 and supplying motor 205 with a power from a second power supply.

Back-up control (module 207) may be configured to supply power to motor 205 by connecting motor 205 with controller 204 in order for controller 204 to govern actuation of the motor during regular operating conditions. Moreover, module 207 may further be configured to disconnect motor 205 from controller 204 and cut-off the power supply from the first power supply 208 of power module 203 and connect motor 205 directly to power module 203. As such, module 207 may supply power to motor 205 from second power supply 208b, for example via battery 210 of power module 203, and supply motor 205 with this alternative power source in order to drive motor 205 during a malfunction or maintenance routine in which controller 204 is unavailable. Hence, module 207 typically includes a switch module including one or more switches or relays that a user may engage or disengage during certain circumstances. In exemplary embodiments, module 207 may comprise one or more switches, a switch mechanism, one or more mechanical switches, one or more relays, a relay matrix, a switch array, electromagnetic switches or relays, solid state devices such as solid state relays, solid state transistor devices such as bipolar junction transistors, field effect transistors, insulated-gate bipolar transistors, or any other suitable device that may enable module 207 to cut-off power from one source and provide power to the motor from the second source. As will be explained further below, one or more switches of such switch module of module 207 may facilitate control of motor 204, by for example providing bidirectional control.

For illustrative purposes, during regular operation operator 202 is configured to draw power from power source 212 via main power supply 208 of power module 203. If sensors 211 malfunction, controller 204 may receive erroneous signals detecting a non-existing obstruction that may prevent controller 204 from generating a signal for closing barrier 201. Since it may be desirable to keep barrier 201 closed at all times, a user may engage a switch on module 207 to temporarily drive motor 205 using the secondary power supply. As such, module 207 may cut-off a power supply from power supply 208 as well as cutting off signals from controller 204 (i.e. that otherwise prevent driving motor 205) in order to drive motor 205 to close barrier 201.

Module 207 may include safety components such as breakers, fuses and the like in order to avoid damaged equipment in case of a malfunction. Furthermore, such safety mechanisms may prevent an undesired voltage surge from driving motor 205 at an unexpected speed or with an unexpected force during operation of barrier 201. For example, and without limiting the scope of the present invention, module 207 may implement fuses, thermal fuse, or breakers, or any other current limiting circuitry. Additionally, electronic circuitry for providing entrapment protection to detect overload or obstructions may be included as well so as to preserve the safety precautions included with the main controller. By way of illustration, if controller 204 needs to be diagnosed (i.e. requiring controller 204 to be cut-off from motor 205), it may be desirable to preserve sensor 211's functionality. As such, sensors 211 may also be connected to module 207, wherein module 207 includes basic circuitry for implementing sensory output such as stopping motor 205 to prevent damage with an obstruction. Of course, it may be desirable to easily disconnect such circuitry in the event that a problem with system 200 involves damaged sensors in the first place.

FIG. 2(b) depicts a block diagram of another embodiment similar to the embodiment shown in FIG. 2(a). More specifically, FIG. 2(b) depicts another embodiment of operator 202. In this embodiment, rather than including a second power supply such as power supply 208b, operator 202 includes power module 203 configured with main power supply 208, which includes power supply interface (PSI) 213 and power supply interface (PSI) 214.

PSI 213 and PSI 214 may be any interface suitable for connecting an operator component to power supply 208. As such, a power supply interface may be a wire, a cable or conduit, or any other device known in the art suitable for transmitting power from a power supply to an electrical component. For example, PSI 213 may be a connection means for connecting power module 203 to controller 204 in order for controller 204 to draw power from power supply 208. Similarly, PSI 214 may be a second power supply interface for connecting power module 203 directly to module 207. In this exemplary embodiment, module 207 may include a switch module connected to motor 205 and configured to either selectively connect the motor to controller 204 in order to actuate movable barrier 201 by supplying power to motor 205 via PSI 213; or selectively connect motor 205 directly to power supply module 203 in order to actuate movable barrier 201 by supplying power to motor 205 via PSI 214.

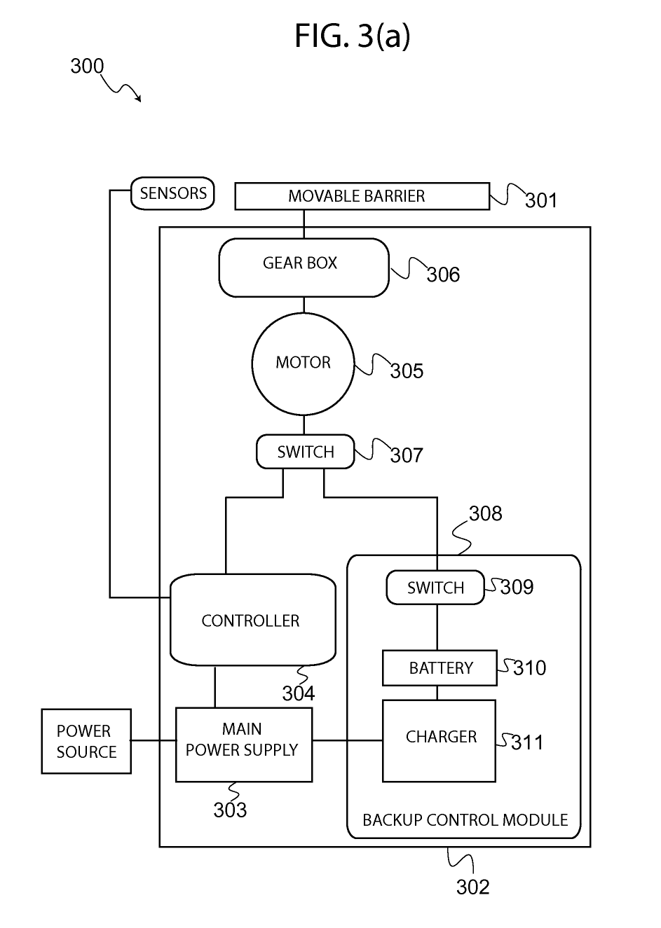

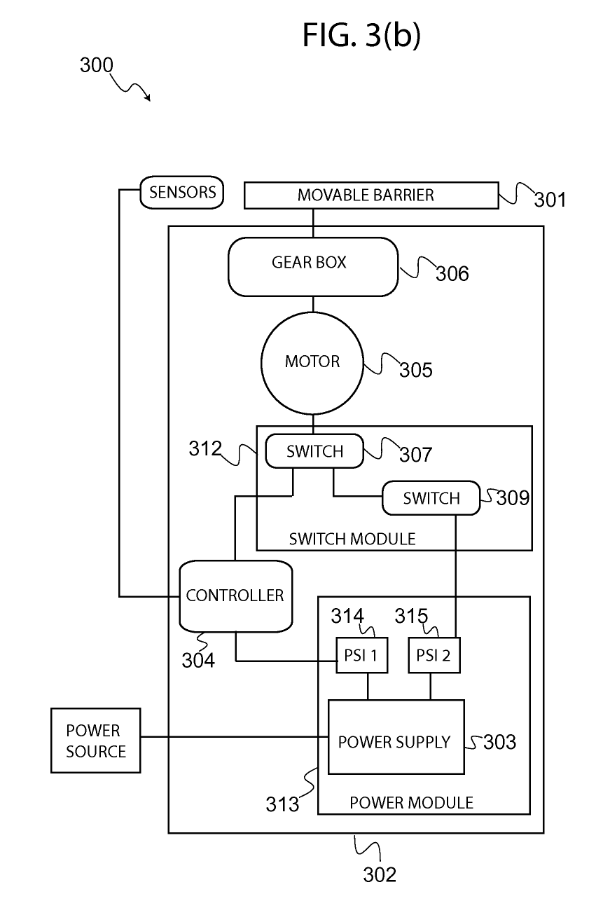

Turning to the next figure, FIG. 3(a) shows one exemplary embodiment of the present invention, which implements a switch and a backup control module that includes a second power supply. In such embodiment, a switch, a relay, or a switch array may be connected to the motor and configured to selectively supply power to the motor via the controller, or selectively supply power to the motor via the backup control module, thereby circumventing the controller. More specifically, FIG. 3(a) shows system 300, which includes barrier 301 and operator 302. As is typically the case, operator 302 draws power from some external power source, and barrier 301 may be configured with travel limit sensors and obstruction sensors for aiding in the operation of the movable barrier.

As with the embodiment shown in the previous a figure, operator 302 may include a first power supply and a second power supply—main power supply 208 and a second power supply (310, 311) included in backup control module 308—as well as controller 304, motor 305, and gearbox 306, which is mechanically coupled to barrier 301.

In the present embodiment, operator 302 further includes a first switch, such as a double pole double throw switch or a relay (switch 307), which selectively connects motor 305 to controller 304 or motor 305 to backup control module 308. Backup control module 308 includes a second switch, such as another double pole double throw switch or another relay (switch 309), which supplies power to motor 305 from a second power source such as batter 310. Switch 309 may be further configured to enable control of motor 305.

Thus, the first switch, switch 307, may be configured to connect main controller 304 to motor 305 in order to provide power and control of motor 305 during regular operation. Thus, during regular operation of operator 302, controller 304 may generate signals that govern actuation of motor 305 in order to move barrier 301 between open and close positions by supplying motor 305 with power from power supply 303. Switch 307 may also selectively connect motor 305 to back-up module 308. Hence, in this embodiment, switch 307 governs cutting off a first power supply to motor 305 and switching to a second power supply and switch 309 of backup control module 308 governs control of motor 305.

In the shown embodiment, module 308 includes the second switch or switch 309. In one embodiment, switch 309 may be a double pole double throw switch configured to connect motor 305 with battery 310 in a manner so as to achieve a bidirectional drive of motor 305. That is, a user may utilize switch 309 to drive motor 305 in one direction (i.e. to close barrier 301) or drive motor 305 in the opposite direction (i.e. to open barrier 301).

For example, and without limiting the scope of the present invention, one exemplary embodiment may incorporate switch 307 and exclude switch 309. In such embodiment, switch 307 may be a double pole double throw switch, which connects with motor 305 at the common terminals of the switch. The normally closed terminals may be connected to the main controller 304. Upon actuating the switch, the motor may be disconnected from the main controller 304 and connects directly to the second power source (battery 310) allowing movement of the barrier in one direction; in such embodiment, switch 307 would be connected directly to battery 310.

In another exemplary embodiment (i.e. as shown in FIG. 3), another double pole double throw switch (switch 309) may be implemented between the alternative power source (battery 310) and first switch (switch 307), in order to allow movement of barrier 301 in the opposite direction (i.e. by connecting the winding of the motors in an opposite polarity to cause movement in the opposite direction).

In one exemplary embodiment, switch 307 and switch 309 are incorporated into a single switching means such as a switch array, switch mechanism, relay array or relay matrix configured to selectively connect motor 305 to controller 304 in order to actuate barrier 301 by supplying power to the motor via the first power supply 303; or selectively connect motor 305 directly to module 308 in order to actuate barrier 301 by supplying power to the motor via the second power supply (i.e. in this case, battery 310). Moreover, as mentioned above, any other switching mechanism may be implemented and switch 307 and switch 309 may comprise mechanical switches, electromagnetic switches or relays, solid state devices such as solid state relays, solid state transistor devices such as bipolar junction transistors, field effect transistors, insulated-gate bipolar transistors, or any other suitable device that may be used a switch.

In yet other embodiments, a single power supply may supply power to the motor, and a switch module may provide a means to connect the motor to the controller, or circumvent the controller and supply the motor with power directly from a similar power module. FIG. 3(b) depicts a block diagram of such embodiment.

FIG. 3(b) depicts another embodiment of operator 302. In this embodiment, rather than including backup control module 308, operator 302 includes power module 313 configured with power supply 303, which includes a first power supply interface (PSI) 314 and a second power supply interface (PSI) 315. Furthermore, operator 302 may include switch module 312 for selectively switching between supplying power to motor 305 via controller 304, or circumventing controller 304 and supplying power to motor 305 directly from power module 313.

For example, and without limiting the scope of the present invention, PSI 314 may connect power module 313 to controller 304, and PSI 315 may connect power module 313 directly to switch module 312. In this exemplary embodiment, switch module 312 may be configured to selectively connect the motor to controller 304 in order to actuate movable barrier 301 by supplying power to motor 305 via PSI 314; or selectively connect motor 305 directly to power supply module 313 in order to actuate movable barrier 301 by supplying power to motor 305 via PSI 315.

In one exemplary embodiment, switch 307 and switch 309 are incorporated into a single switching means; as such switch module 312 may include a switch array, a relay array, a relay matrix, electromagnetic switches or relays, solid state devices such as solid state relays, solid state transistor devices such as bipolar junction transistors, field effect transistors, insulated-gate bipolar transistors, or any type of switching means that may be configured to selectively connect motor 305 to controller 304 in order to actuate barrier 301 by supplying power to the motor via PSI 314; or selectively connect motor 305 directly to module 313 in order to actuate barrier 301 by supplying power to the motor via PSI 315.

Turning now to the next figure, one embodiment of the present invention is depicted wherein a backup control module includes a basic circuitry for providing additional functionality that may be lost without the main controller.

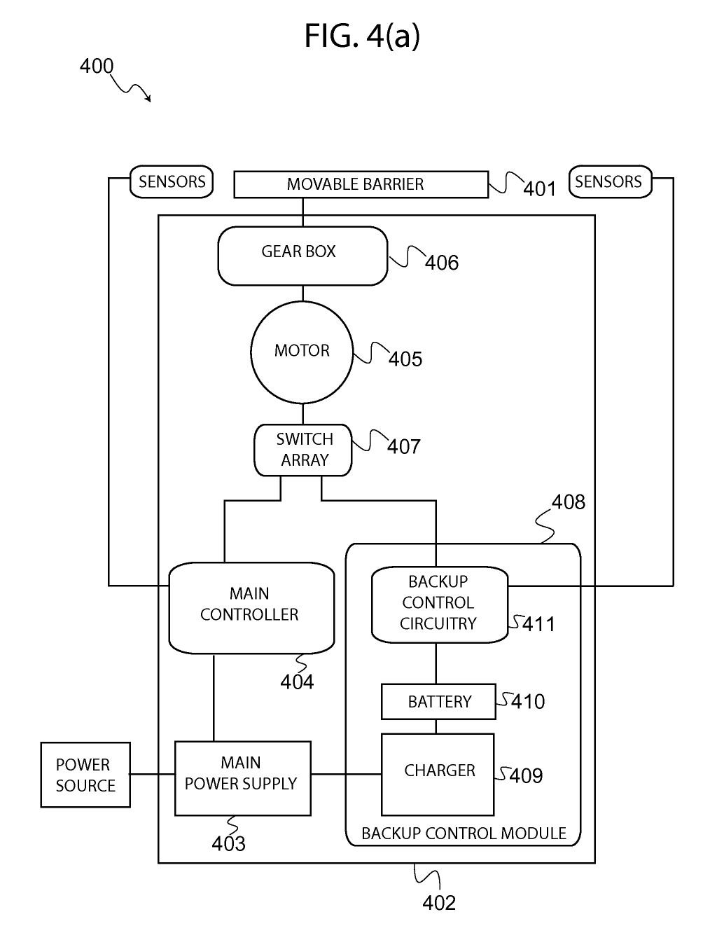

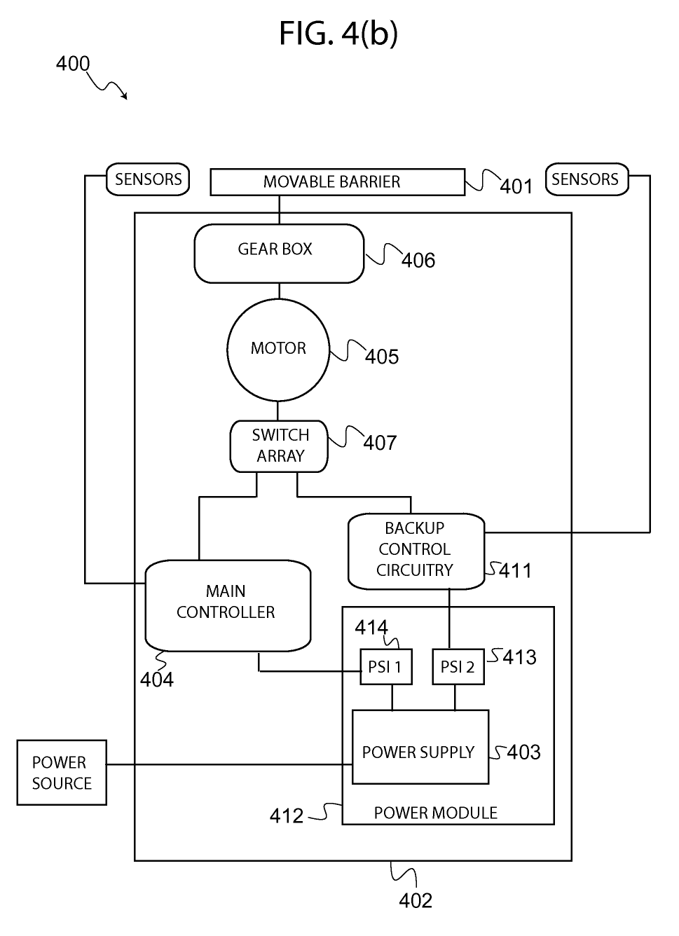

FIG. 4(a) depicts a block diagram of system 400, which includes the use of a secondary or backup control circuitry. Such embodiment may implement entrapment protection and/or current limiting circuitry such as fuses or breakers, to prevent the motor from driving the barrier under certain conditions. For example, the backup control circuitry may detect overload or obstructions in order to preserve the safety precautions included with the main controller.

FIG. 4(a) shows system 400, which includes barrier 401 and operator 402. As is typically the case, operator 402 draws power from some external power source, and barrier 401 may be configured with obstruction sensors within proximity for aiding in the operation of the movable barrier. As with the embodiment shown in the previous a figure, operator 402 includes a first power supply 403 and a second power supply as well as a secondary or backup means of controlling barrier 401 in the event of a malfunction or routine maintenance that requires controller 404 to be taken off line.

Operator 402 includes power supply 403, main controller (controller 404), motor 405, gearbox 406, relay 407, and backup control module 408. Motor 405 of operator 402 is mechanically coupled to barrier 401 via gearbox 406. A first power supply, or power supply 403, is included in operator 402 for selectively supplying power to motor 405 under regular operational conditions. In the event controller 404 needs to be taken off line, operator 402 also includes backup control module 408, which includes a second power supply for selectively supplying power to the motor. In order to select between the first power supply and the second power supply, relay 407 selectively connects motor 405 to controller 404 or backup control module 408.

As such, controller 404 draws power from the first power supply 403 and is configured to actuate movement of barrier 401 by generating a command signal to drive the motor whenever controller 404 is connected to motor 405. As mentioned above, a switch means, such as switch array 407 may be coupled to motor 405, wherein switch array 407 may be configured to selectively connect motor 405 to controller 404 in order to actuate the movable barrier by drawing power from the first power supply 403. If backup control module is required to circumvent having to drive motor 405 via controller 404, switch array 407 may disconnect controller 404 from motor 405 and connect motor 405 to backup control module 408.

In one embodiment, backup control module 408 may include the secondary source of power or second power supply as well as circuitry 411 to preserves some of the functionality offered by controller 404. As shown, backup control module 408 further includes charger 409, which draws power from power supply 403 and charges battery 410 for supplying motor 405 with a secondary power supply.

In one embodiment, switch array 407 may include one or more switches for supplying motor 405 with power from battery 410 as well as provide directional control—for example providing bidirectional control of motor 405.

In one embodiment circuitry 411 may be configured to receive sensory output from one or more sensors in order to detect overload or obstructions. In response to the sensory output from the one or more sensors, circuitry 411 may be configured to stop motor 405 in order to prevent damage or injury under certain conditions.

In yet other embodiments, circuitry 411 may be linked or in communication with existing limit switches or existing sensors, in order to preserve travel limit functionality as well as obstruction sensitivity. Alternatively, secondary limit switches may be implemented in order to avoid problems that may have interfered with controller 4040 (i.e. faulty sensors connected to controller 404). In yet other embodiments, backup control circuitry 411 may implement instructions for a limited run time or the like to dictate a predetermined limit of travel desired.

Yet another embodiment is depicted in FIG. 4(b). In this embodiment, a single power supply is implemented in a configuration similar to the configurations implemented by the embodiments described with reference to FIG. 2(b) and FIG. 3(b). In the embodiment shown in FIG. 4(b), operator 402 includes power module 412 configured to implement a single power supply or power supply 403 as a single power supply for motor 405. As such, this embodiment also includes a first power supply interface (PSI) 413 and a second power supply interface (PSI) 415.

For example, and without limiting the scope of the present invention, PSI 413 may connect power module 412 to controller 404, and PSI 414 may connect power module 412 to circuitry 411. In this exemplary embodiment, switch array 407 may be configured to selectively connect the motor to controller 404 in order to actuate movable barrier 401 by supplying power to motor 405 via PSI 413; or selectively connect motor 405 to circuitry 411 in order to actuate movable barrier 401 by supplying power to motor 405 via PSI 314.

As is evident from the various possible elements and configurations of elements described above, numerous variations exist for a movable barrier operator in accordance with the present invention. For example, an operator in accordance with the present specification may include a controller that is housed in a controller housing, a power supply that is housed in a power supply hosing, and a switch array that is housed in a separate housing from the controller and the power supply. Alternatively, a backup module may be housed in first housing that includes a switch array, while the controller may be housed in a second housing. In yet another embodiment, a single housing may include the switch array and the controller, the housing providing a compact means where a user may access both main controller and switch array via a common user interface panel. As such, many variations and configurations of the elements of the present invention are possible without deviating from the scope of the invention.

A movable barrier operator with a backup control module has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

What is claimed is:

1. An operator for a movable barrier, comprising:
a motor mechanically coupled to a movable barrier;
a power supply module for supplying power to the motor, the power supply module including:
a first power supply interface, and
a second power supply interface;
a controller connected to the power supply module via the first power supply interface, the controller configured to actuate movement of the movable barrier by generating a command signal to drive the motor when the controller is connected to the motor; and
a switch module connected to the motor and configured to:
selectively connect the motor to the controller in order to actuate the movable barrier by supplying power to the motor via the first power supply interface; or
selectively connect the motor directly to the power supply module in order to actuate the movable barrier by supplying power to the motor via the second power supply interface.

2. The operator of claim 1, wherein the switch module comprises:
a first switch coupled to the motor, the first switch configured to selectively connect the motor to the controller in order to actuate the movable barrier by drawing power from the power supply module via the first power supply interface; and
a second switch coupled to the first switch and the power supply module, wherein the first switch is further configured to selectively connect the motor to the second switch, and wherein the second switch is configured to actuate the movable barrier by supplying power to the motor from the power supply module via the second power supply interface.

3. The operator of claim 2, wherein the first and second switch comprise a switch array for selectively connecting the motor to the controller, or the motor to the second switch.

4. The operator of claim 2, wherein the first or second switch comprise a relay.

5. The operator of claim 2, wherein the first and second switch comprise a relay matrix.

6. The operator of claim 2, wherein the second switch is configured to provide bidirectional control of the motor.

7. The operator of claim 1, further comprising:
a circuitry coupled to the power supply module and one or more sensor, the circuitry configured to:
receive sensory output from the one or more sensors, and
stop the motor from driving the movable barrier in response to the sensory output, when the motor is drawing power from the power supply module via the second power supply interface.

8. The operator of claim 8, wherein the circuitry further comprises current limiting circuitry configured to stop the motor from driving the movable barrier in response to detecting an upper limit on the current delivered to the motor, when the motor is drawing power from the power supply module via the second power supply interface.

9. The operator of claim 1, wherein the power supply module further includes:
a first power supply for supplying power to the motor via the first power supply interface of the power supply module; and
a second power supply for supplying power to the motor via the second power supply interface of the power supply module.

10. A movable barrier system, comprising:
a movable barrier; and
a movable barrier operator coupled to the movable barrier, the movable barrier operator including:
a motor mechanically coupled to the movable barrier;
a power supply module for supplying power to the motor, the power supply module including:
a first power supply interface, and
a second power supply interface;
a controller connected to the power supply module via the first power supply interface, the controller configured to actuate movement of the movable barrier by generating a command signal to drive the motor when the controller is connected to the motor; and
a first switch coupled to the motor, the first switch configured to selectively connect the motor to the controller in order to actuate the movable barrier by supplying power to the motor via the first power supply interface; and
a second switch coupled to the first switch and power supply module, wherein the first switch is further configured to selectively connect the motor to the second switch, and wherein the second switch is configured to actuate the movable barrier by supplying power to the motor via the second power supply interface.

11. The operator of claim 10, wherein the first and second switch comprise a switch array for selectively connecting the motor to the controller, or the motor to the second switch.

12. The system of claim 10, wherein the first or second switch comprise a relay.

13. The system of claim 10, wherein the first and second switch comprise a relay matrix.

14. The system of claim 10, wherein the second switch is configured to provide bidirectional control of the motor.

15. The system of claim 10, wherein the power supply module further includes:
a first power supply for supplying power to the motor via the first power supply interface of the power supply module; and
a second power supply for supplying power to the motor via the second power supply interface of the power supply module.

16. The system of claim 10, further comprising:
one or more sensors for generating sensory output concerning one or more parameters of the movable barrier; and
a circuitry coupled to the power supply module and the one or more sensors, the circuitry configured to:
receive sensory output from the one or more sensor, and
stop the motor from driving the movable barrier in response to the sensory output, when the motor is drawing power from the power supply module via the second power supply interface.

17. The system of claim 16, wherein the circuitry further comprises current limiting circuitry configured to stop the motor from driving the movable barrier in response to detecting an upper limit on the current delivered to the motor, when the motor is drawing power from the power supply module via the second power supply interface.

18. A movable barrier operator, comprising:
a motor mechanically coupled to a movable barrier;
a first power supply for selectively supplying power to the motor;
a second power supply including a charger configured to draw power from the first power supply and a battery coupled to the charger and configured to selectively supply power to the motor;
a controller that draws power from the first power supply, the controller configured to actuate movement of the movable barrier by generating a command signal to drive the motor when the controller is connected to the motor;
a switch array connected to the motor and configured to:
selectively connect the motor to the controller in order to actuate the movable barrier by supplying power to the motor via the first power supply; or
selectively connect the motor to the second power supply in order to actuate the movable barrier by supplying power to the motor via the battery.

19. The operator of claim 18, further comprising:
one or more sensors for generating sensory output concerning one or more parameters of the movable barrier; and
a circuitry coupled to the second power supply, the circuitry configured to:
receive sensory output from the one or more sensor, and
stop the motor from driving the movable barrier in response to the sensory output, when the motor is drawing power from the second power supply.

20. The operator of claim 19, wherein the circuitry further comprises current limiting circuitry configured to stop the motor from driving the movable barrier in response to detecting an upper limit on the current delivered to the motor, when the motor is drawing power from the second power supply.
